(19) United States
(12) Patent Application Publication
(10) Pub. No.: US 2021/0126263 A1
(43) Pub. Date: Apr. 29, 2021

(54) REDOX FLOW BATTERY ELECTRODE AND REDOX FLOW BATTERY

(71) Applicant: Sumitomo Electric Industries, Ltd., Osaka-shi, Osaka (JP)

(72) Inventors: Takahiro IKEGAMI, Osaka-shi (JP); Yong-rong DONG, Osaka-shi (JP); Masayuki OYA, Osaka-shi (JP); Ryojun SEKINE, Osaka-shi (JP)

(73) Assignee: Sumitomo Electric Industries, Ltd., Osaka-shi, Osaka (JP)

(21) Appl. No.: 17/056,777

(22) PCT Filed: Apr. 25, 2019
(86) PCT No.: PCT/JP2019/017589

§ 371 Date: Nov. 19, 2020

(30) Foreign Application Priority Data
Jun. 12, 2018 (JP) 2018-112349

(51) Int. Cl. H01M 4/90; H01M 8/18; H01M 4/38

(52) U.S. Cl. CPC H01M 4/9041; H01M 2004/027; H01M 4/38; H01M 8/188

(57) ABSTRACT

A redox flow battery electrode includes a substrate and a catalytic unit supported on the substrate. The substrate contains at least one element selected from the group consisting of C, Ti, Sn, Ta, Ce, In, W, and Zn, and the catalytic unit contains at least one element selected from the group consisting of Fe, Si, Mo, Ce, Mn, Cu, and W.

### TECHNICAL FIELD

The present disclosure relates to a redox flow battery electrode and a redox flow battery.

### BACKGROUND ART

PTL 1 discloses a redox flow battery that performs charging and discharging by supplying a pair of electrodes (a positive electrode and a negative electrode) disposed on both sides of a membrane with their respective electrolytes (a positive electrolyte and a negative electrolyte) and thereby causing electrochemical reactions (electrode reactions) on the electrodes. Carbon fiber aggregates having chemical resistance, electrical conductivity, and liquid permeability are used for the electrodes.

### CITATION LIST

### Patent Literature

PTL 1: Japanese Unexamined Patent Application Publication No. 2002-246035

### SUMMARY OF INVENTION

A redox flow battery electrode according to the present disclosure includes

a substrate and a catalytic unit supported on the substrate.

The substrate contains at least one element selected from the group consisting of C, Ti, Sn, Ta, Ce, In, W, and Zn, and

the catalytic unit contains at least one element selected from the group consisting of Fe, Si, Mo, Ce, Mn, Cu, and W.

A redox flow battery according to the present disclosure performs charging and discharging by supplying a positive electrolyte and a negative electrolyte to a battery cell that includes a positive electrode, a negative electrode, and a membrane disposed between the positive electrode and the negative electrode.

The positive electrode is the above redox flow battery electrode according to the present disclosure.

### BRIEF DESCRIPTION OF DRAWINGS

FIG. 1A is a schematic view illustrating a redox flow battery electrode according to an embodiment.

FIG. 1B is an enlarged view illustrating a redox flow battery electrode according to an embodiment.

FIG. 1C is a partial sectional view taken along line (C)-(C) in FIG. 1B.

FIG. 2 is a sectional view illustrating another example of how a catalytic unit is supported on a substrate in a redox flow battery electrode according to an embodiment.

FIG. 3 is a sectional view illustrating still another example of how a catalytic unit is supported on a substrate in a redox flow battery electrode according to an embodiment.

FIG. 4 illustrates an operating principle of a redox flow battery according to an embodiment.

FIG. 5 is a schematic configuration of a redox flow battery according to an embodiment.

FIG. 6 is a schematic configuration of a cell stack included in a redox flow battery according to an embodiment.

FIG. 7 is a cyclic voltammogram in Test Example 1.

FIG. 8 is a linear sweep voltammogram in Test Example 2.

### DESCRIPTION OF EMBODIMENTS

[Problems to be Solved by Present Disclosure]

Further improvement in battery performance of redox flow batteries has been demanded, and further improvement in electrode reactions has been strongly desired.

Thus, an object of the present disclosure is to provide a redox flow battery electrode that can construct a redox flow battery having high battery reactivity on the electrode and a low cell resistivity. Another object of the present disclosure is to provide a redox flow battery having high battery reactivity on the electrode and a low cell resistivity.

[Advantageous Effects of Present Disclosure]

A redox flow battery electrode of the present disclosure can construct a redox flow battery having high battery reactivity on the electrode and a low cell resistivity. A redox flow battery of the present disclosure has high battery reactivity on the electrode and a low cell resistivity.

[Description of Embodiments of Present Disclosure]

First, embodiments of the present disclosure will be described in sequence.

(1) A redox flow battery electrode according to an embodiment of the present disclosure includes

a substrate and a catalytic unit supported on the substrate.

The substrate contains at least one element selected from the group consisting of C, Ti, Sn, Ta, Ce, In, W, and Zn, and

the catalytic unit contains at least one element selected from the group consisting of Fe, Si, Mo, Ce, Mn, Cu, and W.

The elements listed as constituent elements of the substrate in the above element group (hereinafter referred to as an element group A) are elements less prone to oxidation degradation. The elements listed as constituent elements of the catalytic unit in the above element group (hereinafter referred to as an element group B) are elements readily supported on the substrate constituted by an element in the element group A. The elements in the element group B are elements that effectively exhibit a catalytic function when supported on the substrate constituted by an element in the element group A. Furthermore, the elements in the element group B are non-noble metal elements and are less expensive than noble metal elements commonly used as catalysts.

Due to the inclusion of an element in the element group A in the substrate, the redox flow battery electrode of the present disclosure is less likely to undergo degradation over time during a long-term operation of a redox flow battery and is highly durable. Due to the inclusion of an element in the element group B in the catalytic unit, the redox flow battery electrode of the present disclosure can construct a redox flow battery having high battery reactivity on the electrode and a low cell resistivity. Furthermore, the redox flow battery electrode of the present disclosure can achieve more reduction in cost than when the catalytic unit is constituted by a noble metal element.

(2) In an embodiment of the redox flow battery electrode of the present disclosure,

the mass proportion of the catalytic unit in the redox flow battery electrode may be 0.01% or more and 70% or less.

When the mass proportion of the catalytic unit (hereinafter referred to as the ratio of the catalytic unit) in the redox flow battery electrode is 0.01% or more, battery reactivity on the electrode is readily increased, and a redox flow battery having a lower cell resistivity can be constructed. As the ratio of the catalytic unit increases, the battery reactivity on the electrode becomes more readily increased, but the ratio of the substrate relatively decreases, resulting in a reduction in durability of the redox flow battery electrode. Thus, the ratio of the catalytic unit is preferably 70% or less, in which case a redox flow battery electrode having higher battery reactivity on the electrode and high durability is readily provided.

(3) In an embodiment of the redox flow battery electrode of the present disclosure,

the catalytic unit may have a portion exposed on the substrate and a portion buried in the substrate.

When the catalytic unit has a portion buried in the substrate, the catalytic unit is firmly supported on the substrate. Accordingly, falling off of the catalytic unit from the substrate tends to be suppressed during a long-term operation of a redox flow battery. On the other hand, when the catalytic unit has a portion exposed on the substrate, catalysis can be exhibited since the beginning of use of the redox flow battery electrode of the present disclosure.

(4) In an embodiment of the redox flow battery electrode of the present disclosure,

the catalytic unit may include

a first catalytic unit having a portion exposed on the substrate, and

a second catalytic unit not exposed on the substrate but buried in the substrate.

The first catalytic unit having a portion exposed on the substrate can exhibit catalysis since the beginning of use of the redox flow battery electrode of the present disclosure. In contrast, the second catalytic unit not exposed on the substrate but buried in the substrate will be exposed when the electrode is degraded during a long-term operation of a redox flow battery, and can exhibit catalysis since the exposure. Thus, due to the presence of both the first catalytic unit and the second catalytic unit, catalysis can be exhibited over a long period of time since the beginning of use of the redox flow battery electrode of the present disclosure. This is because the second catalytic unit is supported on the substrate even if the first catalytic unit fell off the substrate due to the degradation of the electrode during the long-term operation of the redox flow battery.

(5) In an embodiment of the redox flow battery electrode of the present disclosure,

the electrode may include a binder that covers at least part of the catalytic unit.

Due to the presence of the binder that covers the catalytic unit, the catalytic unit is firmly supported on the substrate. Therefore, falling off of the catalytic unit from the substrate tends to be suppressed during a long-term operation of a redox flow battery.

(6) A redox flow battery according to an embodiment of the present disclosure performs charging and discharging by supplying a positive electrolyte and a negative electrolyte to a battery cell that includes a positive electrode, a negative electrode, and a membrane disposed between the positive electrode and the negative electrode.

The positive electrode is the redox flow battery electrode according to any one of (1) to (5).

Due to the use of the redox flow battery electrode of the present disclosure as the positive electrode, the redox flow battery of the present disclosure has high battery reactivity on the electrode and a low cell resistivity. This can be explained as follows: in a redox flow battery, side reactions that accompany charging and discharging tend to cause oxidation degradation of a positive electrode, leading to an increase in cell resistivity; thus, the cell resistivity can be effectively reduced by using the redox flow battery electrode of the present disclosure as the positive electrode.

(7) In an embodiment of the redox flow battery,

the negative electrode may be the redox flow battery electrode according to any one of (1) to (5).

By using the redox flow battery electrode of the present disclosure also as the negative electrode, the cell resistivity can be further reduced.

(8) In an embodiment of the redox flow battery,

the positive electrolyte may contain manganese ions as a positive electrode active material, and

the negative electrolyte may contain titanium ions as a negative electrode active material.

In the case of a manganese-titanium electrolyte containing manganese ions as a positive electrode active material and titanium ions as a negative electrode active material, the positive electrode is prone to oxidation degradation. Thus, by using the redox flow battery electrode of the present disclosure as the positive electrode in the case of a manganese-titanium electrolyte, the cell resistivity can be effectively reduced.

(9) In an embodiment of the redox flow battery containing manganese ions as a positive electrode active material and titanium ions as a negative electrode active material,

the concentration of the manganese ions and the concentration of the titanium ions may each be 0.3 mol/L or more and 5 mol/L or less.

When the concentration of the manganese ions and the concentration of the titanium ions are each 0.3 mol/L or more, a manganese-titanium-based redox flow battery sufficiently containing metal elements that undergo valence change reactions and having a high energy density can be obtained. On the other hand, when the concentration of the manganese ions and the concentration of the titanium ions are each 5 mol/L or less, satisfactory dissolution can be achieved even if the electrolyte is an aqueous solution of an acid, and the electrolyte is easily producible.

[Details of Embodiments of Present Disclosure]

Details of a redox flow battery electrode and a redox flow battery according to embodiments of the present disclosure will be described below with reference to the drawings. Like reference signs in the drawings refer to like parts.

<<Redox Flow Battery Electrode>>

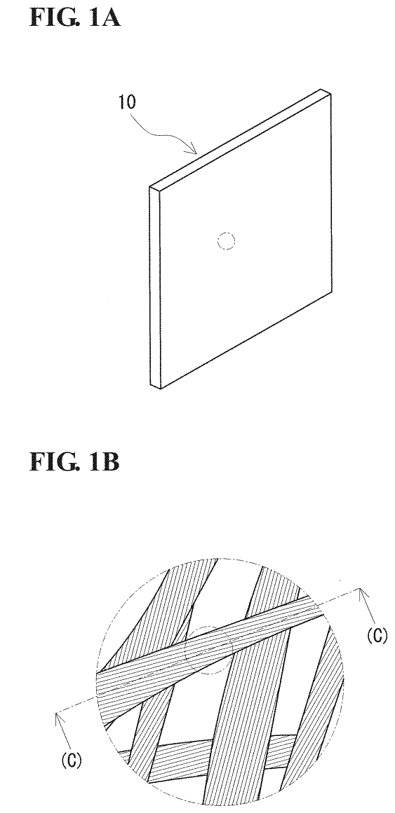

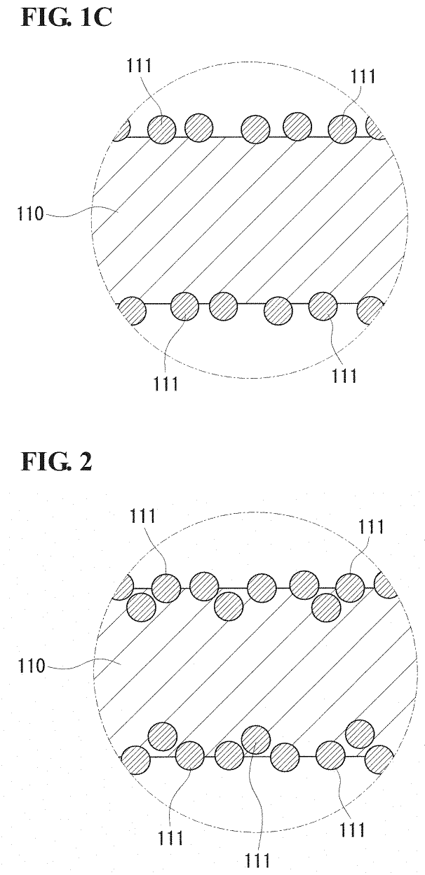

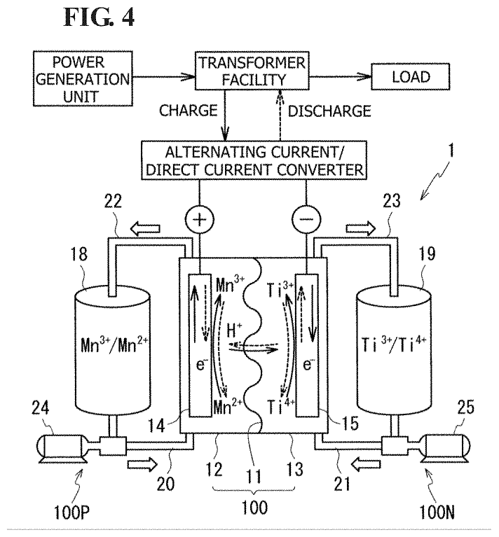

A redox flow battery electrode 10 (hereinafter also referred to simply as an “electrode”) according to an embodiment will be described with reference to FIG. 1 to FIG. 3. The electrode 10 according to an embodiment is used as a component of a redox flow battery 1 (FIG. 4) and serves as a reaction site where an active material contained in an electrolyte undergoes a battery reaction. FIG. 1A is a general view of the electrode 10. FIG. 1B is a partially enlarged view of the electrode 10. The electrode 10 is formed of a fiber aggregate composed mainly of a plurality of fibers entangled together, as illustrated in FIG. 1B. FIG. 1B schematically illustrates a plurality of fibers forming the electrode 10. FIG. 1C is a sectional view of each fiber (a substrate 110) forming the electrode 10, the view being taken along a plane parallel to the longitudinal direction of the fiber. The electrode 10 includes the substrate 110 and a catalytic unit 111 supported on the substrate 110, as illustrated in FIG. 1C. One feature of the electrode 10 according to an embodiment is to contain a particular element as an element constituting the substrate 110 and a particular element as an element constituting the catalytic unit 111.

[Substrate]

The substrate 110 contains at least one element selected from the group consisting of carbon (C), titanium (Ti), tin (Sn), tantalum (Ta), cerium (Ce), indium (In), tungsten (W), and zinc (Zn). The substrate 110 may be a material composed of a single element or a material composed of an alloy or a compound containing the at least one element. The substrate 110 may also contain an element other than the elements listed above. The substrate 110 forms the base of the electrode 10. The proportion of the substrate 110 in the electrode 10 may be 30 mass % or more and 99 mass % or less. The proportion of fibers in the fiber aggregate (the electrode 10) varies depending on the structure (the form of combination of the fibers) of the substrate 110. Examples of the form of combination of the fibers in the fiber aggregate include nonwoven fabric, woven fabric, and paper.

The average diameter of cross sections of the fibers forming the substrate 110 may be 3 μm or more and 100 μm or less in terms of equivalent circle diameter. As used herein, a cross section of a fiber is a section taken along a plane parallel to the direction perpendicular to the longitudinal direction of the fiber. When the equivalent circle diameter of the fibers is 3 μm or more, the strength of the aggregate of the fibers can be ensured. On the other hand, when the equivalent circle diameter of the fibers is 100 μm or less, the surface area per unit weight of the fibers can be large, which enables a sufficient battery reaction. The equivalent circle diameter of the fibers may further be 5 μm or more and 50 μm or less, and may particularly be 7 μm or more and 20 μm or less. As used herein, the equivalent circle diameter refers to a diameter of a perfect circle having the same area as the above cross section of a fiber. The average diameter of cross sections of the fibers forming the substrate 110 can be determined by cutting the electrode 10 to expose the cross sections of the fibers, measuring three or more fibers in each of five or more fields under a microscope, and averaging the measurement results.

The porosity of the fiber aggregate formed of the substrate 110 may be more than 40 vol % and less than 98 vol %. When the porosity of the fiber aggregate is more than 40 vol %, electrolyte flowability can be improved. On the other hand, when the porosity of the fiber aggregate is less than 98 vol %, the fiber aggregate has a high density so that electrical conductivity can be improved, which enables a sufficient battery reaction. The porosity of the fiber aggregate formed of the substrate 110 may further be 60 vol % or more and 95 vol % or less, and may particularly be 70 vol % or more and 93 vol % or less.

[Catalytic Unit]

The catalytic unit 111 contains at least one element selected from the group consisting of iron (Fe), silicon (Si), molybdenum (Mo), cerium (Ce), manganese (Mn), copper (Cu), and tungsten (W). The catalytic unit 111 is preferably composed of a non-noble metal element containing the at least one element listed above. When the catalytic unit 111 contains one element selected from the above element group, the catalytic unit 111 may contain a simple substance of the element, an oxide of the element, or both a simple substance of the element and an oxide of the element. When the catalytic unit 111 contains a plurality of elements selected from the above element group, the catalytic unit 111 may contain simple substances of the plurality of elements, oxides of the plurality of elements, a compound containing the plurality of elements, a solid solution containing the plurality of elements, or a combination thereof. For example, when the plurality of elements selected from the above element group are X and Y, the simple substances of the two elements may be X+Y, the oxides of the two elements may be XₙOₘ+YₚO_{q}, and the compound (composite oxide) containing the two elements may be (Xₛ,Yₜ)O. In particular, the catalytic unit 111 often contains an element (or elements) selected from the above element group in the form of oxide. While the catalytic unit 111 may contain an element other than the elements listed above, the element is also preferably a non-noble metal element. The catalytic unit 111 is supported on the substrate 110 and improves battery reactivity on the electrode 10.

The substrate 110 and the catalytic unit 111 may contain the same element. In this case, the substrate 110 may be composed of a simple substance of the element, and the catalytic unit 111 may be composed of a compound of the element. The compound may be an oxide. For example, when both the substrate 110 and the catalytic unit 111 contain W, the catalytic unit 111 composed of W oxide may be supported on the substrate 110 composed of a simple substance of W. When both the substrate 110 and the catalytic unit 111 contain Ce, the catalytic unit 111 composed of Ce oxide may be supported on the substrate 110 composed of a simple substance of Ce. Even when the substrate 110 and the catalytic unit 111 contain the same element, the element contained in the substrate 110 and the element contained in the catalytic unit 111 can be distinguished from each other by observing their crystal structures under a transmission electron microscope (TEM). This is because a simple substance of an element and a compound of the element have different crystal structures.

The catalytic unit 111 is supported on the substrate 110. As used herein, being supported means that the catalytic unit 111 is electrically connected and fixed to the substrate 110. The catalytic unit 111 may be directly fixed to the substrate 110, or the catalytic unit 111 may be indirectly fixed to the substrate 110. In the case where the catalytic unit 111 is directly fixed to the substrate 110, the catalytic unit 111 may stick to the surface of the substrate 110, as illustrated in FIG. 1C. Alternatively, in the case where the catalytic unit 111 is directly fixed to the substrate 110, at least part of the catalytic unit 111 may be buried in the substrate 110, as illustrated in FIG. 2. Specifically, the catalytic unit 111 may have a portion exposed on the substrate 110 and a portion buried in the substrate 110. When the catalytic unit 111 has a portion exposed on the substrate 110, catalysis can be exhibited since the beginning of use of the electrode 10. On the other hand, when the catalytic unit 111 has a portion buried in the substrate 110, the catalytic unit 111 is firmly supported on the substrate 110, and falling off of the catalytic unit 111 from the substrate 110 tends to be suppressed during a long-term operation of the redox flow battery 1 (FIG. 4). Alternatively, the catalytic unit 111 may be not exposed on the substrate 110 but buried in the substrate 110, as illustrated in FIG. 2. When the catalytic unit 111 is completely buried in the substrate 110, the catalytic unit 111 will be exposed when the electrode 10 is degraded over time. The exposed catalytic unit 111 exhibits catalysis. The catalytic unit 111 sticking to the surface of the substrate 110 (FIG. 1C), the catalytic unit 111 partially buried in the substrate 110 (FIG. 2), and the catalytic unit 111 completely buried in the substrate 110 (FIG. 2) may coexist. The catalytic unit 111 completely buried in the substrate 110 cannot exhibit catalysis at the beginning of use of the electrode 10. Therefore, the catalytic unit 111 having a portion exposed on the substrate 110 is necessarily included.

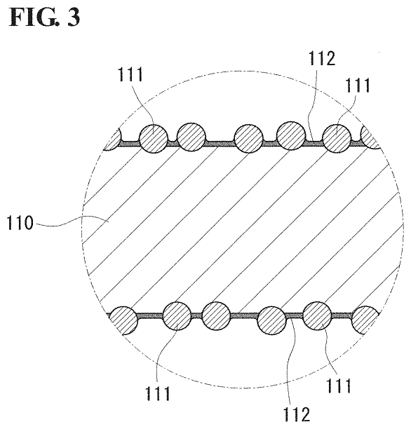

The electrode 10 may include a binder 112 that covers at least part of the catalytic unit 111, as illustrated in FIG. 3. The binder 112 may be disposed throughout the substrate 110 and the catalytic unit 111 so as to cover them. In the case where the catalytic unit 111 is indirectly fixed to the substrate 110, the catalytic unit 111 may, rather than stick to the substrate 110, be fixed in contact with the substrate 110 through the binder 112. When the binder 112 is included, the substrate 110 and the catalytic unit 111 may be not in contact with each other, and the binder 112 may be interposed between the substrate 110 and the catalytic unit 111. When the substrate 110 and the catalytic unit 111 are not in contact with each other, the catalytic unit 111 and the substrate 110 cannot be electrically connected to each other. Therefore, when the binder 112 is included, the catalytic unit 111 in direct contact with the substrate 110 is necessarily included. The catalytic unit 111 may be directly fixed to the substrate 110 while also being fixed through the binder 112. That is, the electrode 10 may include the catalytic unit 111 sticking to the substrate 110 and the catalytic unit 111 having a portion buried in the substrate 110 and further include the binder 112. In any case, the catalytic unit 111 is firmly supported on the substrate 110 due to the presence of the binder 112. The catalytic unit 111 completely covered by the binder 112 cannot exhibit catalysis at the beginning of use of the electrode 10. Therefore, the catalytic unit 111 having a portion exposed on the binder 112 is necessarily included.

The binder 112 contains at least one element selected from the group consisting of carbon (C), aluminum (Al), and phosphorus (P). The mass proportion of the binder 112 in the electrode 10 may be 1% or more and 50% or less, and may further be 20% or more and 40% or less. The above mass proportion is a mass proportion of the total content of the element constituting the binder 112 based on 100 mass % of the total content of the substrate 110, the catalytic unit 111, and the binder 112. The mass proportion of the binder 112 can be determined by thermogravimetry (TG).

The catalytic unit 111 is typically a solid. Examples of the solid include granular bodies, acicular bodies, rectangular parallelepipeds, short fibers, and long fibers. Typically, the catalytic unit 111 is substantially uniformly distributed throughout the entire area of the substrate 110, as illustrated in FIG. 1C. The catalytic unit 111 may have a portion in direct close contact with the substrate 110. This is because the catalytic unit 111 containing the particular element described above tends to effectively produce a catalytic effect when directly supported on the substrate 110 containing the particular element described above. The catalytic unit 111 containing the particular element described above tends to be directly supported on the substrate 110 containing the particular element described above.

The mass proportion of the catalytic unit 111 (the ratio of the catalytic unit 111) in the electrode 10 may be 0.01% or more and 70% or less. The ratio of the catalytic unit 111 is a mass proportion of the total content of the element constituting the catalytic unit 111 based on 100 mass % of the electrode 10. For example, when the electrode 10 is composed of the substrate 110 and the catalytic unit 111, the total content of the substrate 110 and the catalytic unit 111 is 100 mass %. When the electrode 10 is composed of the substrate 110, the catalytic unit 111, and the binder 112 (FIG. 3), the total content of the substrate 110, the catalytic unit 111, and the binder 112 is 100 mass %. When the ratio of the catalytic unit 111 is 0.01% or more, battery reactivity on the electrode 10 is readily increased, and the redox flow battery 1 having a lower cell resistivity can be constructed. As the ratio of the catalytic unit 111 increases, the battery reactivity on the electrode 10 becomes more readily increased, but the ratio of the substrate 110 relatively decreases, resulting in a reduction in durability of the electrode 10. Thus, the ratio of the catalytic unit 111 is preferably 70% or less, whereby the electrode 10 having higher battery reactivity on the electrode 10 and high durability is readily provided. The ratio of the catalytic unit 111 may further be 0.1% or more and 70% or less, 1% or more and 70% or less, and may particularly be 10% or more and 50% or less, 10% or more and 30% or less. The ratio of the catalytic unit 111 can be determined by TG.

[Basis Weight]

The basis weight (weight per unit area) of the electrode 10 may be 50 g/m² or more and 10,000 g/m² or less. When the basis weight of the electrode 10 is 50 g/m² or more, a sufficient battery reaction can be performed. On the other hand, when the basis weight is 10,000 g/m² or less, pores cannot be excessively small, and an increase in electrolyte flow resistance tends to be suppressed. The basis weight of the electrode 10 may further be 100 g/m² or more and 2,000 g/m² or less, and may particularly be 200 g/m² or more and 700 g/m² or less.

[Thickness]

The thickness of the electrode 10 under no external force is preferably 0.1 mm or more and 5 mm or less. When the thickness of the electrode 10 in the above state is 0.1 mm or more, a battery reaction site where a battery reaction with an electrolyte is performed can be enlarged. On the other hand, when the thickness of the electrode 10 in the above state is 5 mm or less, the redox flow battery 1 including the electrode 10 can be thin. The thickness of the electrode 10 in the above state may further be 0.2 mm or more and 2.5 mm or less, and may particularly be 0.3 mm or more and 1.5 mm or less.

<<Method for Producing Redox Flow Battery Electrode>>

The electrode 10 described above is obtained by preparing a substrate 110 and a coating liquid containing a constituent element of a catalytic unit 111, applying the coating liquid to the surface of the substrate 110, and performing a heat treatment.

As the substrate 110, a fiber aggregate in which fibers containing at least one element selected from the group consisting of C, Ti, Sn, Ta, Ce, In, W, and Zn are entangled together is prepared. The size and shape of the fiber aggregate are appropriately selected so that the electrode 10 will have a desired size and shape. The prepared fiber aggregate may be subjected, before use, to a blasting treatment, an etching treatment, or the like to have an enlarged surface area or a roughened surface. After the blasting treatment or the etching treatment, selective etching of the surface is performed, and cleaning and activation are performed. Typical examples of acids used for acid cleaning in the cleaning include sulfuric acid, hydrochloric acid, and hydrofluoric acid. The activation can be performed by immersing the fiber aggregate into a solution of such an acid to dissolve part of the surface.

A coating liquid containing a raw material of an element constituting the catalytic unit 111 and a solvent is prepared. Examples of the raw material of the element constituting the catalytic unit 111 include metal alkoxides, chlorides, acetates, and organometallic compounds. Specific examples include ammonium tungstate pentahydrate, tungsten chloride, and sodium tungstate hydrate. Other examples include iron chloride, hexaammonium heptamolybdate tetrahydrate, cerium carbonate, manganese sulfate, and copper sulfate. The solvent may be water or an organic solvent. Examples of the organic solvent include methanol, ethanol, propyl alcohol, isopropanol, butanol, pentanol, and hexanol. The solvent may be contained in an amount of 70 mass % or more and 95 mass % or less relative to the total amount of the coating liquid. The coating liquid may contain a stabilizer such as acetylacetone. The stabilizer may be contained in an amount of 1 mass % or more and 10 mass % or less relative to the total amount of the coating liquid. The substance containing these raw materials, the solvent, and further the stabilizer is stirred in a nitrogen atmosphere for about 1 hour or more and 5 hours or less, whereby a desired coating liquid containing the constituent element of the catalytic unit 111 is obtained.

The coating liquid obtained is applied to the surface of the fiber aggregate obtained. Examples of methods of the application include brush coating, spraying, dip coating, flow coating, and roll coating. After the coating liquid is applied to the fiber aggregate, drying is performed. Thereafter, the fiber aggregate to which the coating liquid is applied is heat-treated in an oxygen-containing atmosphere at 300° C. or higher and 700° C. or lower for 10 minutes or more and 5 hours or less. The oxygen-containing atmosphere may be an oxidizing atmosphere or an atmosphere whose oxidation state is adjusted in a gas containing reducing gas, and may be, for example, air. When the heat treatment temperature is 300° C. or higher and the heat treatment time is 10 minutes or more, the catalytic unit 111 can be stuck to the substrate 110 substantially uniformly throughout the entire area of the substrate 110. On the other hand, when the heat treatment temperature is 700° C. or lower and the heat treatment time is 5 hours or less, the ratio of the catalytic unit 111 relative to the substrate 110 cannot be excessively high. The heat treatment temperature may further be 400° C. or higher and 600° C. or lower, and may particularly be 450° C. or higher and 550° C. or lower. The heat treatment time may further be 15 minutes or more and 2 hours or less, and may particularly be 30 minutes or more and 1 hour or less.

As a result of the above heat treatment, the constituent element of the catalytic unit 111 permeates into the fiber aggregate through thermal diffusion, and the catalytic unit 111 is brought into close contact, in a dispersed manner, with the outer peripheral surface of each fiber (the substrate 110) forming the fiber aggregate. In the electrode 10 obtained by applying the coating liquid to the surface of the substrate 110 and then performing a heat treatment, the catalytic unit 111 is mainly sticking to the surface of the substrate 110. In the electrode 10 obtained by performing the heat treatment, part of the catalytic unit 111 may be buried in the substrate 110.

Alternatively, the catalytic unit 111 can be supported on the substrate 110 by using a physical vapor deposition (PVD) process or a chemical vapor deposition (CVD) process. The PVD process may be a sputtering process. Specifically, a simple substance of an element constituting the catalytic unit 111 or an oxide of the element is deposited on the prepared substrate 110 by a PVD process or a CVD process. When the simple substance of the element constituting the catalytic unit 111 is deposited on the substrate 110, a heat treatment may be performed after the deposition. This heat treatment oxidizes the element deposited on the substrate 110. The heat treatment may be performed in an oxygen-containing atmosphere, such as air, at 300° C. or higher and 700° C. or lower for 15 minutes or more and 2 hours or less. In the electrode 10 obtained using a PVD process or a CVD process, the catalytic unit 111 is mainly in a state where part of the catalytic unit 111 is buried in the substrate 110.

In supporting the catalytic unit 111 on the substrate 110 by using a PVD process or a CVD process, the catalytic unit 111 can also be completely buried in the substrate 110 by melting the surface of the prepared substrate 110.

The electrode 10 including the binder 112 is obtained by applying a binder solution containing a constituent element of the catalytic unit 111 to the surface of the substrate 110 and performing a heat treatment. The binder solution contains a raw material of the element constituting the catalytic unit 111, a raw material of an element constituting the binder 112, and a solvent. The raw material of the element constituting the catalytic unit 111 and the raw material of the element constituting the binder 112 may be simple substances of the elements. The solvent may be water or an organic solvent. Examples of methods for applying the binder solution to the substrate 110 include brush coating, spraying, dip coating, flow coating, and roll coating. After the binder solution is applied to the substrate 110, drying is performed. Thereafter, the substrate 110 to which the binder solution is applied is heat-treated in an oxygen-containing atmosphere, such as air, at 300° C. or higher and 700° C. or lower for 15 minutes or more and 2 hours or less.

<<Redox Flow Battery>>

A redox flow battery (RF battery) 1 according to an embodiment will be described with reference to FIG. 4 to FIG. 6. Typically, the RF battery 1 is connected, through an alternating current/direct current converter, a transformer facility, and the like, to a power generation unit and a load such as a power system or a consumer, as illustrated in FIG. 4. The RF battery 1 is charged using the power generation unit as a power supply source and is discharged using the load as a power supply target. Examples of the power generation unit include solar photovoltaic power generators, wind power generators, and other general power plants.

The RF battery 1 includes a battery cell 100 and circulation mechanisms (a positive electrode circulation mechanism 100P and a negative electrode circulation mechanism 100N) configured to supply electrolytes to the battery cell 100 in a circulating manner, as illustrated in FIG. 4. The battery cell 100 is divided by a membrane 11 into a positive electrode cell 12 and a negative electrode cell 13. The positive electrode cell 12 contains a positive electrode 14 to which a positive electrolyte is supplied, and the negative electrode cell 13 contains a negative electrode 15 to which a negative electrolyte is supplied. One feature of the RF battery 1 according to an embodiment is that the positive electrode 14 is formed of the electrode 10 according to the embodiment described above. In this example, the negative electrode 15 is also formed of the electrode 10 according to the embodiment described above.

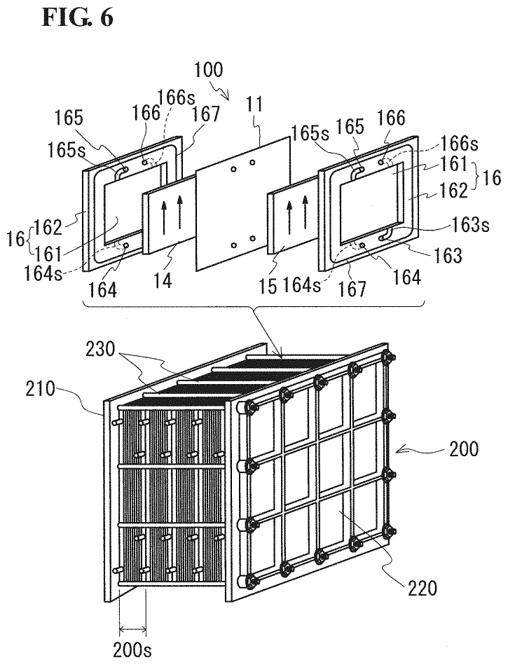

The battery cell 100 is sandwiched between a pair of cell frames 16, as illustrated in FIG. 6. The cell frames 16 each include a bipolar plate 161 and a frame body 162 surrounding the outer periphery of the bipolar plate 161. The positive electrode 14 and the negative electrode 15 are disposed on front and rear surfaces of the bipolar plate 161.

The membrane 11 is a separation member that separates the positive electrode 14 and the negative electrode 15 from each other and that is permeable to specific ions. The bipolar plate 161 is formed of a conductive member that conducts electric current but is impermeable to electrolytes. The positive electrode 14 is disposed on one surface (front surface) side of the bipolar plate 161 so as to be in contact with the bipolar plate 161, and the negative electrode 15 is disposed on the other surface (rear surface) side of the bipolar plate 161 so as to be in contact with the bipolar plate 161. Inside the frame body 162, a region that serves as the battery cell 100 is formed. Specifically, the frame body 162 is thicker than the bipolar plate 161. The frame body 162 surrounds the outer periphery of the bipolar plate 161, whereby a step is formed between the front (rear) surface of the bipolar plate 161 and the front (rear) surface of the frame body 162. Inside the step, a space in which the positive electrode 14 (the negative electrode 15) is disposed is formed.

The positive electrode circulation mechanism 100P, which supplies the positive electrolyte to the positive electrode cell 12 in a circulating manner, includes a positive electrolyte tank 18, pipes 20 and 22, and a pump 24. The positive electrolyte tank 18 stores the positive electrolyte. The pipes 20 and 22 connect the positive electrolyte tank 18 with the positive electrode cell 12. The pump 24 is provided in the pipe 20 on the upstream side (supply side). The negative electrode circulation mechanism 100N, which supplies the negative electrolyte to the negative electrode cell 13 in a circulating manner, includes a negative electrolyte tank 19, pipes 21 and 23, and a pump 25. The negative electrolyte tank 19 stores the negative electrolyte. The pipes 21 and 23 connect the negative electrolyte tank 19 with the negative electrode cell 13. The pump 25 is provided in the pipe 21 on the upstream side (supply side).

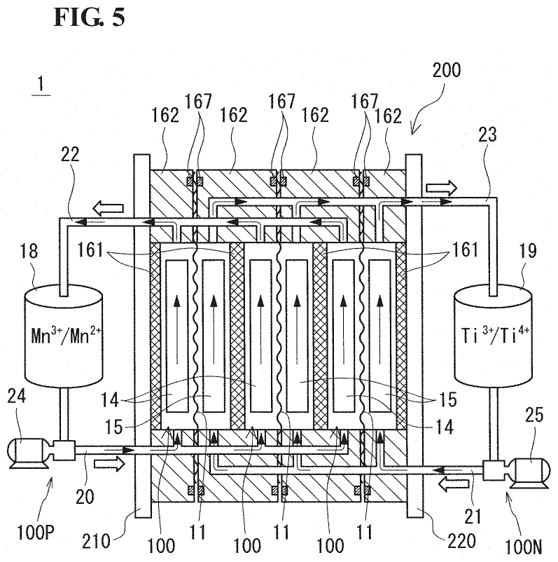

The positive electrolyte is supplied from the positive electrolyte tank 18 to the positive electrode 14 through the pipe 20 on the upstream side and returned from the positive electrode 14 to the positive electrolyte tank 18 through the pipe 22 on the downstream side (drainage side). The negative electrolyte is supplied from the negative electrolyte tank 19 to the negative electrode 15 through the pipe 21 on the upstream side and returned from the negative electrode 15 to the negative electrolyte tank 19 through the pipe 23 on the downstream side (drainage side). In FIG. 4 and FIG. 5, manganese (Mn) ions and titanium (Ti) ions respectively shown in the positive electrolyte tank 18 and the negative electrolyte tank 19 are examples of ion species contained in the positive electrolyte and the negative electrolyte as active materials. In FIG. 4, solid line arrows indicate charging, and broken line arrows indicate discharging. Upon circulation of the positive electrolyte and circulation of the negative electrolyte, the positive electrolyte is supplied to the positive electrode 14 in a circulating manner, and the negative electrolyte is supplied to the negative electrode 15 in a circulating manner, while the active material ions in the positive and negative electrolytes undergo valence change reactions to cause charging and discharging.

For example, the positive electrolyte may contain, as a positive electrode active material, at least one selected from manganese ions, vanadium ions, iron ions, polyacids, quinone derivatives, and amines. The negative electrolyte may contain, as a negative electrode active material, at least one selected from titanium ions, vanadium ions, chromium ions, polyacids, quinone derivatives, and amines. The concentration of the positive electrode active material and the concentration of the negative electrode active material can be appropriately selected. For example, at least one of the concentration of the positive electrode active material and the concentration of the negative electrode active material may be 0.3 mol/L or more and 5 mol/L or less. When the concentrations are 0.3 mol/L or more, an energy density sufficient for high-capacity storage batteries (e.g., about 10 kWh/m³) can be achieved. The higher the concentrations, the higher the energy density. Thus, the concentrations may be 0.5 mol/L or more, and may further be 1.0 mol/L or more, 1.2 mol/L or more, and 1.5 mol/L or more. In view of the solubility in a solvent, the concentrations may be 5 mol/L or less, and may further be 2 mol/L or less for ease of use and producibility of the electrolytes. The electrolytes may each be, for example, an aqueous solution containing, in addition to the active material, at least one acid or acid salt selected from sulfuric acid, phosphoric acid, nitric acid, and hydrochloric acid.

The RF battery 1 is typically used in the form called a cell stack 200 in which a plurality of battery cells 100 are stacked. As illustrated in FIG. 6, the cell stack 200 includes a layered body in which a cell frame 16, a positive electrode 14, a membrane 11, a negative electrode 15, and another cell frame 16 are repeatedly stacked, a pair of end plates 210 and 220 between which the layered body is sandwiched, coupling members 230 such as long bolts, and fastening members such as nuts. The coupling members 230 and the fastening members join the end plates 210 and 220 together. The fastening members tighten the end plates 210 and 220 toward each other, and the stacked state of the layered body is maintained by the tightening force in the stacking direction. The cell stack 200 is used in the form a stack of a plurality of substacks 200S, each being formed of a predetermined number of battery cells 100. In the cell frame 16 located at each end of the substacks 200S or the cell stack 200 in the stacking direction of the battery cells 100, a supply/drainage plate (not illustrated) is disposed instead of the bipolar plate 161.

The positive and negative electrolytes are respectively supplied to the positive electrode 14 and the negative electrode 15 through liquid supply manifolds 163 and 164, liquid supply slits 163s and 164s, and a liquid supply regulator (not illustrated), which are formed on one of opposite sides (liquid supply side, the lower side in the drawing plane of FIG. 6) of the frame body 162 of the cell frame 16. The positive and negative electrolytes are respectively drained from the positive electrode 14 and the negative electrode 15 through a liquid drainage regulator (not illustrated), liquid drainage slits 165s and 166s, and liquid drainage manifolds 165 and 166, which are formed on the other one of the opposite sides (liquid drainage side, the upper side in the drawing plane of FIG. 6) of the frame body 162. The positive electrolyte is supplied from the liquid supply manifold 163 to the positive electrode 14 through the liquid supply slit 163s formed on one surface (the front surface in the drawing plane) side of the frame body 162. The positive electrolyte then flows from the lower side to the upper side of the positive electrode 14 as indicated by arrows in the upper part of FIG. 6, and is drained out of the liquid drainage manifold 165 through the liquid drainage slit 165s formed on one surface (the front surface in the drawing plane) side of the frame body 162. The negative electrolyte is supplied and drained in the same manner as the positive electrolyte except that the supply and drainage are conducted on the other surface (the back surface in the drawing plane) side of the frame body 162. Ring-shaped sealing members 167 (FIG. 5 and FIG. 6) such as O-rings or flat gaskets are disposed between the frame bodies 162 in order to prevent leakage of the electrolytes from the battery cells 100. Sealing grooves (not illustrated) for receiving the ring-shaped sealing members 167 are formed in the frame body 162 along its periphery.

The basic configuration of the RF battery 1 described above can be appropriately selected from known configurations.

[Advantageous Effects]

In the redox flow battery electrode 10 according to an embodiment, the catalytic unit 111 containing at least one element selected from the element group B consisting of particular elements is supported on the substrate 110 containing at least one element selected from the element group A consisting of particular elements. With this configuration, the electrode 10 can construct an RF battery 1 having high reactivity with electrolytes and a low cell resistivity. The element group A consists of C, Ti, Sn, Ta, Ce, In, W, and Zn. The element group B consists of Fe, Si, Mo, Ce, Mn, Cu, and W. The elements in the element group B are readily supported on the substrate 110 constituted by an element in the element group A. When supported on the substrate 110 constituted by an element in the element group A, the elements in the element group B effectively exhibit a catalytic function. In particular, when the mass proportion of the catalytic unit 111 in the electrode 10 is 0.01% or more, battery reactivity on the electrode 10 is readily increased, and an RF battery 1 having a lower cell resistivity can be constructed.

In an embodiment of the electrode 10, part of the catalytic unit 111 is buried in the substrate 110, and part of the catalytic unit 111 is covered by the binder 112. In this configuration, the catalytic unit 111 tends to be firmly supported on the substrate 110. When the catalytic unit 111 is firmly supported on the substrate 110, falling off of the catalytic unit 111 from the substrate 110 tends to be suppressed during a long-term operation of the RF battery 1. Due to the presence of a second catalytic unit 111 not exposed on the substrate 110 but buried in the substrate 110 in addition to a first catalytic unit 111 having a portion exposed on the substrate 110, catalysis can be exhibited over a long period of time since the beginning of use of the electrode 10. Due to the catalysis exhibited over a long period of time, the reactivity between the electrode 10 and electrolytes can be maintained at a satisfactory level over a long period of time. This is because during the long-term operation of the RF battery 1, the second catalytic unit 111 is exposed when the electrode 10 is degraded, and the catalysis can be exhibited since the exposure. That is, the second catalytic unit 111 is supported on the substrate 110 even if the first catalytic unit 111 fell off the substrate 110 due to the degradation of the electrode 10 during the long-term operation of the RF battery 1.

Due to the inclusion of an element in the element group A in the substrate 110, the electrode 10 is less prone to oxidation degradation, is less likely to undergo degradation over time during a long-term operation of the RF battery 1, and is highly durable. Furthermore, due to the inclusion of an element in the element group B in the catalytic unit 111, the electrode 10 can achieve more reduction in cost than when a noble metal element commonly used as a catalyst is used alone.

Due to the use of the redox flow battery electrode 10 according to an embodiment as the positive electrode 14, the RF battery 1 according to an embodiment has high battery reactivity on the electrode and a low cell resistivity. This can be explained as follows: in the RF battery 1, side reactions that accompany charging and discharging tend to cause oxidation degradation of the positive electrode 14, leading to an increase in cell resistivity; thus, the cell resistivity can be effectively reduced by using the electrode 10 as the positive electrode 14. In particular, when the electrolyte of the RF battery 1 is a manganese-titanium electrolyte containing manganese ions as a positive electrode active material and titanium ions as a negative electrode active material, the positive electrode is prone to oxidation degradation. Thus, by using the electrode 10 as the positive electrode 14, the cell resistivity can be effectively reduced.

The RF battery 1 can be used for natural energy power generation, such as solar photovoltaic power generation and wind power generation, as a high-capacity storage battery used for stabilization of fluctuations in power output, storage of surplus power, load leveling, etc. The RF battery 1 can be suitably used also as a high-capacity storage battery that is placed in a general power plant and used as a measure against voltage sag and power failure or for load leveling.

### TEST EXAMPLE 1

An electrode including catalytic units containing a non-noble metal element was produced, and the battery reactivity on the electrode and the cell resistivity of an RF battery including the electrode were examined.

[Preparation of Sample]

Sample No. 1-1

An electrode including a substrate and catalytic units supported on the substrate was prepared.

As the substrate, a fiber aggregate having a size of 3.3 mm×2.7 mm and a thickness of 0.45 mm was prepared using a sheet of carbon paper formed of a plurality of carbon fibers. The fiber aggregate had a porosity of 85 vol %, and the fiber diameter of each carbon fiber was 10 μm in terms of equivalent circle diameter.

As a coating liquid containing a constituent element of the catalytic units, an aqueous solution containing ammonium tungstate pentahydrate ((NH₄)₁₀ W₁₂O₄₁.5H₂O) was prepared. The amount of solvent (water) was 1 mass % relative to the total amount of the coating liquid.

The substrate was immersed in the coating liquid to make the coating liquid stick to the outer peripheral surface of the substrate (carbon fibers). The substrate to which the coating liquid was stuck was dried and then heat-treated at 480° C. for 1 hour.

A section of the resulting electrode (sample No. 1-1) was examined using a scanning electron microscope and an analyzer employing energy dispersive X-ray spectroscopy (SEM-EDX). As a result, it was found that in the electrode of sample No. 1-1, the catalytic units were substantially uniformly distributed over the outer peripheral surface of the substrate (carbon fibers). It was also found that catalytic units sticking to the outer peripheral surface of the substrate (carbon fibers) and catalytic units partially buried in the substrate (carbon fibers) coexisted. The state of existence of the catalytic units was examined by measuring the crystal structure by X-ray diffractometry (XRD) and measuring the elementary composition with an X-ray microanalyzer (EPMA). As a result, it was found that the catalytic units existed in the form of tungsten oxide (WO₃). The mass proportion of the catalytic units in the electrode was 20%.

Sample No. 1-11

As an electrode, a substrate that was the same as the substrate of sample No. 1-1 was prepared. The electrode of sample No. 1-11 was composed only of the substrate and includes no catalytic units.

[Battery Reactivity]

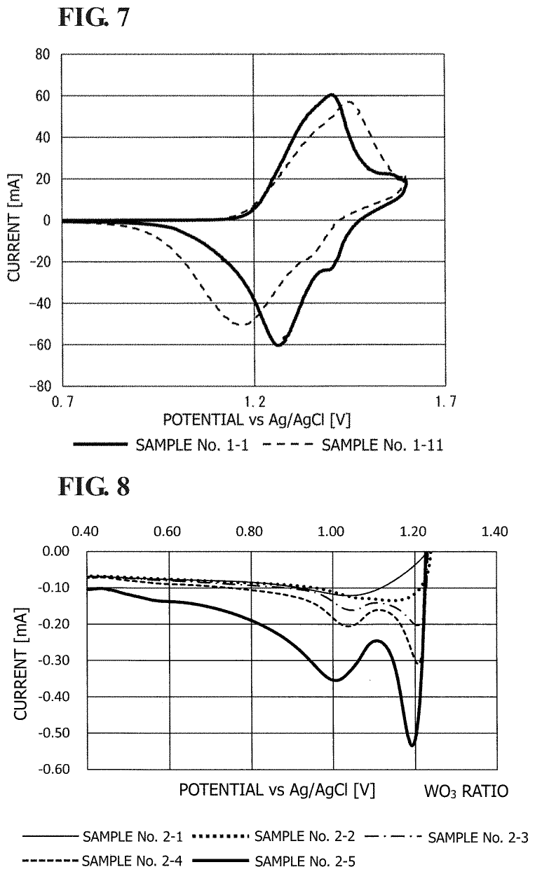

The above electrodes of sample No. 1-1 and sample No. 1-11 were each immersed in a preliminarily charged electrolyte, and potential scanning was performed. The electrolyte contained manganese ions at a concentration of 1.0 mol/L. The potential scanning was repeatedly performed at 3 mV/s in the range from 0.5 V to 1.6 V using a silver/silver chloride electrode as a reference electrode until a stationary cyclic voltammogram was obtained. The results are shown in FIG. 7. In FIG. 7, the horizontal axis represents applied potential, and the vertical axis represents response current. In the cyclic voltammogram curve in FIG. 7, upper curves represent oxidation waves, and lower curves represent reduction waves. In FIG. 7, sample No. 1-1 is indicated by a solid line, and sample No. 1-11 is indicated by a broken line.

In the cyclic voltammograms shown in FIG. 7, when the oxidation waves or reduction waves of sample No. 1-1 and sample No. 1-11 are compared with each other, a larger absolute value of current indicates higher battery reactivity on the electrode. Comparison between the oxidation waves of sample No. 1-1 and sample No. 1-11 shows that sample No. 1-1 has a peak value of current at a potential of about 1.40 V, and sample No. 1-11 has a peak value of current at a potential of about 1.46 V. Sample No. 1-1 has a larger absolute value of current than sample No. 1-11. Comparison between the reduction waves of sample No. 1-1 and sample No. 1-11 shows that sample No. 1-1 has a peak value of current at a potential of about 1.26 V, and sample No. 1-11 has a peak value of current at a potential of about 1.17 V. Sample No. 1-1 has a larger absolute value of current than sample No. 1-11. The reason why the absolute value of current of sample No. 1-1 is larger is probably that the catalytic units formed of tungsten oxide were supported on the substrate formed of carbon fibers, and thus the catalytic function of the catalytic units was effectively exhibited. When the catalytic function of the catalytic units is effectively exhibited, the battery reactivity on the electrode can be improved.

In the cyclic voltammograms shown in FIG. 7, when the oxidation wave potentials and the reduction wave potentials of sample No. 1-1 and sample No. 1-11 are compared with each other, a smaller potential difference between points near peak values of current indicates higher battery reactivity on the electrode. As a result, sample No. 1-1 has a smaller potential difference than sample No. 1-11. The reason why the potential difference of sample No. 1-1 is smaller is probably that the catalytic units formed of tungsten oxide were supported on the substrate formed of carbon fibers, and thus the catalytic function of the catalytic units was effectively exhibited. When the catalytic function of the catalytic units is effectively exhibited, the battery reactivity on the electrode can be improved.

[Cell Resistivity]

RF batteries having a single-cell structure were produced using a positive electrode, a negative electrode, and a membrane. As the positive electrode, the above electrode of sample No. 1-1 or sample No. 1-11 was used. As the negative electrode, the same electrode as sample No. 1-11 (carbon fiber aggregate including no catalytic units) was used. A manganese-titanium electrolyte including a positive electrolyte containing manganese ions as an active material and a negative electrolyte containing titanium ions as an active material was used as an electrolyte. Since each sample was an RF battery having a single-cell structure, the internal resistance of the RF battery is represented as a cell resistivity. For each sample, the battery cell was charged and discharged at a constant current with a current density of 256 mA/cm². In this test, when a predetermined switching voltage set in advance was reached, switching was performed from charging to discharging, and a plurality of cycles of charging and discharging were performed. After each cycle of charging and discharging, the cell resistivity (Ω·cm²) was determined for each sample. The cell resistivity was determined by determining an average voltage during charging and an average voltage during discharging in one cycle randomly selected from the plurality of cycles and calculating {(difference between average voltage during charging and average voltage during discharging)/(average current/2)}×effective cell area. In this example, the cell resistivity of an electrode immediately after the start of immersion in the electrolyte (on day 0 of immersion) was determined.

As a result, the cell resistivity of sample No. 1-1 was 0.76 Ω·cm², and that of sample No. 1-11 was 0.83 Ω·cm². The reason why the cell resistivity of sample No. 1-1 was lower than that of sample No. 1-11 is probably that the catalytic units formed of tungsten oxide were supported on the substrate formed of carbon fibers, and thus the catalytic function of the catalytic units was effectively exhibited and the battery reactivity on the electrode was improved.

### TEST EXAMPLE 2

As an electrode including catalytic units containing a non-noble metal element, a dummy electrode in which the mass proportion of the catalytic units (the ratio of the catalytic units) in the electrode was varied was produced, and the battery reactivity at the catalytic units was examined.

[Preparation of Samples]

Sample Nos. 2-1 to 2-5

A dummy electrode including an electrically conductive material and catalytic units held inside the electrically conductive material was produced. In producing the dummy electrode, a cylindrical member made of plastic was first provided. Next, a brass rod was inserted into a hollow portion at one end side of the cylindrical member, and carbon paste oil (electrically conductive material) and a powder (tungsten oxide (WO₃) powder) forming the catalytic units in each sample were loaded into a hollow portion at the other end side. The powder was compressed to obtain the dummy electrode. In each sample, the ratio of carbon paste oil to the catalytic units (the above powder) was varied. Specifically, the ratio of the catalytic units was 0 mass % in sample No. 2-1, 17 mass % in sample No. 2-2, 25 mass % in sample No. 2-3, 50 mass % in sample No. 2-4, and 67 mass % in sample No. 2-5. The ratio of the catalytic units is a mass proportion of the content of the catalytic units based on 100 mass % of the total content of carbon paste oil and the catalytic units (the above powder).

[Battery Reactivity]

Using the above electrodes of sample Nos. 2-1 to 2-5, linear sweep voltammetry was performed. Specifically, the above electrodes of sample Nos. 2-1 to 2-5 were each immersed in a preliminarily charged electrolyte, and potential scanning was performed. The electrolyte contained manganese ions at a concentration of 1.0 mol/L. The potential scanning was performed at 3 mV/s from the open circuit voltage (1.23 V) of the charged electrolyte toward lower potentials using a silver/silver chloride electrode as a reference electrode. The results are shown in FIG. 8. In FIG. 8, the horizontal axis represents applied potential, and the vertical axis represents response current. In FIG. 8, sample No. 2-1 is indicated by a thin solid line, sample No. 2-2 by a dotted line, sample No. 2-3 by a dash-dotted line, sample No. 2-4 by a broken line, and sample No. 2-5 by a thick solid line.

In the linear sweep voltammograms shown in FIG. 8, higher peak potentials indicate higher speeds of battery reaction on the electrode. The peak potential of sample No. 2-1 is 1.04 V, and the peak potentials of sample Nos. 2-2 to 2-5 are about 1.20 V. The potential of 1.20 V is considered to be a potential for reduction from Mn³⁺ to Mn²⁺ in the electrolyte. Sample Nos. 2-2 to 2-5 have higher peak potentials than sample No. 2-1. The reason why the peak potentials of sample Nos. 2-2 to 2-5 are higher is probably that the catalytic function of the catalytic units was effectively exhibited, and the battery reactivity on the electrode was improved.

In the linear sweep voltammograms shown in FIG. 8, larger absolute values of peak current indicate higher battery reactivity on the electrode. Comparison of sample Nos. 2-2 to 2-5 shows that there are peak values of current at a potential of about 1.2 V and that the absolute value of peak current increases as the ratio of tungsten increases. The reason why this tendency is shown is probably that the higher the ratio of the catalytic units was, the more effectively the catalytic function of the catalytic units was exhibited, and the battery reactivity on the electrode was improved.

### TEST EXAMPLE 3

As an electrode including catalytic units containing a non-noble metal element, a dummy electrode in which the constituent element of the catalytic units was changed was produced, and the battery reactivity at the catalytic units was examined.

[Preparation of Samples]

Sample Nos. 3-1 to 3-6 and 3-11

A dummy electrode including an electrically conductive material and catalytic units held inside the electrically conductive material was produced in the same manner as in Test Example 2. In each sample, the constituent element of powder forming the catalytic units was varied. In sample No. 3-1, manganese oxide (MnO₂) powder was used. In sample No. 3-2, copper oxide (CuO₂) powder was used. In sample No. 3-3, cerium oxide (CeO₂) powder was used. In sample No. 3-4, silicon oxide (SiO₂) powder was used. In sample No. 3-5, molybdenum oxide (MoO₃) powder was used. In sample No. 3-6, iron oxide (FeO) powder was used. In each of sample Nos. 3-1 to 3-6, the ratio of the catalytic units (the above powder) was 25 mass %. Sample No. 3-11 is composed only of carbon paste oil. That is, sample No. 3-11 is composed of 100 mass % of carbon paste oil and 0 mass % of catalytic units (the above powder).

[Battery Reactivity]

Linear sweep voltammetry was performed using the above dummy electrodes of sample Nos. 3-1 to 3-6 and 3-11. The measurement conditions were the same as in Test Example 2. The results are shown in Table 1. Table 1 shows peak voltages and peak currents at the peak voltages.

TABLE 1

| Sample | | Peak potential | Peak current value |
|---|---|---|---|
| No. | Catalytic unit | (V) | (mA) |
| 3-1 | MnO₂ | 1.20 | −0.48 |
| 3-2 | CuO₂ | 1.20 | −0.27 |
| 3-3 | CeO₂ | 1.21 | −0.19 |
| 3-4 | SiO₂ | 1.17 | −0.30 |
| 3-5 | MoO₃ | 1.18 | −0.27 |
| 3-6 | FeO | 1.07 | −0.13 |
| 3-11 | — | 1.04 | −0.12 |

As shown in Table 1, sample Nos. 3-1 to 3-6 have higher peak potentials and higher battery reaction speeds than sample No. 3-11. Sample Nos. 3-1 to 3-6 have larger absolute values of peak current and higher battery reactivity than sample No. 3-11. The reason why this tendency is shown is probably that the catalytic function of the catalytic units was effectively exhibited, and the battery reactivity on the electrode was improved.

### TEST EXAMPLE 4

An electrode including catalytic units containing a non-noble metal element was produced, and the battery reactivity on the electrode was examined.

[Preparation of Sample]

Sample No. 4-1

An electrode including a substrate and catalytic units supported on the substrate was prepared.

As the substrate, a fiber aggregate having a size of 3.3 mm×2.7 mm and a thickness of 0.45 mm was prepared using a sheet of carbon paper formed of a plurality of carbon fibers. The fiber aggregate had a porosity of 85 vol %, and the fiber diameter of each carbon fiber was 10 μm in terms of equivalent circle diameter.

As a coating liquid containing a constituent element of the catalytic units, an aqueous solution containing manganese sulfate (MnSO₄) was prepared. The amount of solvent (water) was 1 mass % relative to the total amount of the coating liquid.

The substrate was immersed in the coating liquid to make the coating liquid stick to the outer peripheral surface of the substrate (carbon fibers). The substrate to which the coating liquid was stuck was dried and then heat-treated at 480° C. for 1 hour.

A section of the resulting electrode (sample No. 4-1) was examined using a scanning electron microscope and an analyzer employing energy dispersive X-ray spectroscopy (SEM-EDX). As a result, it was found that in the electrode of sample No. 4-1, the catalytic units were substantially uniformly distributed over the outer peripheral surface of the substrate (carbon fibers). The state of existence of the catalytic units was examined by measuring the crystal structure by X-ray diffractometry (XRD) and measuring the elementary composition with an X-ray microanalyzer (EPMA). As a result, it was found that the catalytic units existed in the form of manganese oxide (MnO₃). The mass proportion of the catalytic units in the electrode was 20%.

Sample No. 4-11

As an electrode, a substrate that was the same as the substrate of sample No. 4-1 was prepared. The electrode of sample No. 4-11 was composed only of the substrate and includes no catalytic units.

[Battery Reactivity]

Linear sweep voltammetry was performed using the above electrodes of sample No. 4-1 and sample No. 4-11. The measurement conditions were the same as in Test Example 2. The results are shown in Table 2. Table 2 shows peak voltages and peak currents at the peak voltages.

TABLE 2

| Sample | Peak potential | Peak current value |
|---|---|---|
| No. | (V) | (mA) |
| 4-1 | 1.14 | −30.0 |
| 4-11 | 1.11 | −25.3 |

As shown in Table 2, sample No. 4-1 has a higher peak potential and a higher battery reaction speed than sample No. 4-11. Sample No. 4-1 has a larger absolute value of peak current and higher battery reactivity than sample No. 4-11. The reason why this tendency is shown is probably that the catalytic function of the catalytic units was effectively exhibited, and the battery reactivity on the electrode was improved.

It should be understood that the present invention is not limited to these examples; rather, the present invention is defined by the claims, and all changes which come within the meaning and range of equivalency of the claims are intended to be embraced therein. For example, the compositions of the substrate and the catalytic units can be changed with particular elements in particular ranges, and the type of electrolyte can be changed.

### REFERENCE SIGNS LIST

1 redox flow battery (RF battery)

100 battery cell

11 membrane

10 electrode

110 substrate, 111 catalytic unit, 112 binder

12 positive electrode cell, 13 negative electrode cell

14 positive electrode, 15 negative electrode

16 cell frame

161 bipolar plate, 162 frame body

163, 164 liquid supply manifold, 165, 166 liquid drainage manifold

163s, 164s liquid supply slit, 165s, 166s liquid drainage slit

167 sealing member

100P positive electrode circulation mechanism, 100N negative electrode circulation mechanism

18 positive electrolyte tank, 19 negative electrolyte tank

20, 21, 22, 23 pipe, 24, 25 pump

200 cell stack

200S substack

210, 220 end plate, 230 coupling member

1. A redox flow battery electrode comprising a substrate and a catalytic unit supported on the substrate,
wherein the substrate contains at least one element selected from the group consisting of C, Ti, Sn, Ta, Ce, In, W, and Zn, and
the catalytic unit contains at least one element selected from the group consisting of Fe, Si, Mo, Ce, Mn, Cu, and W.

2. The redox flow battery electrode according to claim 1, wherein a mass proportion of the catalytic unit in the redox flow battery electrode is 0.01% or more and 70% or less.

3. The redox flow battery electrode according to claim 1, wherein the catalytic unit has a portion exposed on the substrate and a portion buried in the substrate.

4. The redox flow battery electrode according to claim 1, wherein the catalytic unit includes
a first catalytic unit having a portion exposed on the substrate, and
a second catalytic unit not exposed on the substrate but buried in the substrate.

5. The redox flow battery electrode according to claim 1, comprising a binder that covers at least part of the catalytic unit.

6. A redox flow battery that performs charging and discharging by supplying a positive electrolyte and a negative electrolyte to a battery cell that includes a positive electrode, a negative electrode, and a membrane disposed between the positive electrode and the negative electrode,
wherein the positive electrode is the redox flow battery electrode according to claim 1.

7. The redox flow battery according to claim 6, wherein the negative electrode is the redox flow battery electrode.

8. The redox flow battery according to claim 6, wherein the positive electrolyte contains manganese ions as a positive electrode active material, and
the negative electrolyte contains titanium ions as a negative electrode active material.

9. The redox flow battery according to claim 8, wherein a concentration of the manganese ions and a concentration of the titanium ions are each 0.3 mol/L or more and 5 mol/L or less.
